(19) United States
(12) Patent Application Publication
(10) Pub. No.: US 2008/0231896 A1
(43) Pub. Date: Sep. 25, 2008

(54) Printing device, and printing method and computer readable medium therefor

(75) Inventors: Kunihiko Sakurai, Gifu (JP); Norio Mizutani, Mie-gun (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/076,478

(22) Filed: Mar. 19, 2008

(30) Foreign Application Priority Data
Mar. 20, 2007 (JP) 2007-073661

(51) Int. Cl. G06F 15/00; G06K 1/00

(52) U.S. Cl. 358/1.15; 358/1.1; 358/1.16

(57) ABSTRACT

A printing device includes a data acquiring unit configured to acquire a numerical number of image files to be printed, an input accepting unit configured to accept an external input for specifying a numerical number of papers to be printed, a printing pattern determining unit configured to determine a numerical number, layout, and size of images to be printed on each paper based on the numerical number of image files that is acquired by the data acquiring unit and the numerical number of papers that is specified through the input accepting unit, and a printing unit configured to perform a printing operation based on the numerical number, layout, and size of images to be printed on each paper that are determined by the printing pattern determining unit.

### CROSS-REFERENCE TO RELATED APPLICATION

This application claims priority under 35 U.S.C. §119 from Japanese Patent Application No. 2007-073661 filed on Mar. 20, 2007. The entire subject matter of the application is incorporated herein by reference.

### BACKGROUND

1. Technical Field

The following description relates to one or more printing techniques that make it possible to print a plurality of images so as to efficiently apportion the images onto a predetermined number of papers.

2. Related Art

A printing device is provided with a function of printing a plurality of images set in a matrix state on a single paper, for example, in case of printing the plurality of images taken by a digital camera. According to a printing device disclosed in Japanese Patent Provisional Publication No. 2005-35201, when image data are read into the device, the total number of images to be formed based on the image data is detected, and then an optimum one is selected from previously stored templates so as to minimize the number of papers to be used for the printing operation. The previously stored templates include templates configured such that there are arranged on a single paper 2 images, 4 images, 9 images, 16 images, and 25 images as shown in FIGS. 8A to 8E, respectively. Therefore, for example, when trying to print 11 images, the template with 16 images printable on a single image, which is shown in FIG. 8D, is selected as an optimum template that makes it possible to print all the 11 images on a single paper, and the 11 images are printed in accordance with layout of the selected template.

### SUMMARY

However, in the conventional printing device configured as above, for example, when printing the 11 images, 11 areas are only occupied with the images among the 16 areas provided in the selected template, and non-occupied areas are left as a blank space, as shown in FIG. 9. Therefore, a user may have an impression that such a blank space is wasteful. In addition, since an image Py in the template with 16 images printable in a single paper has a small size, the user may feel it hard to visually recognize details of the images, especially in case where the images are of low quality. Hence, it may be favorable that the images are printed with a larger size, even though it results in an increased number of used papers. In such a case, when selecting the template with 9 images printable on a single paper as shown in FIG. 8C, 9 images are printed on a printing paper Z1, and the other 2 images are printed on another printing paper Z2, as shown in FIG. 10.

In the above case, since a single image Pz in the template with 9 images printable on a single paper has a larger size, it is made easier to visually recognize the details of the images. However, since a wide blank space is generated on the printing paper Z2, the user may have an impression that such a wide blank space is wasteful. Furthermore, when comparing the printing papers Z1 and Z2, there is a significant difference in the number of printed images on each printing paper. Such a significant difference may give the user an unfavorable impression.

Thus, according to the conventional printing device, it is possible to perform the printing operation based on a desired one of previously prepared templates so as to minimize the number of papers to be used, or to optimize the size of each printed image. However, as described above, the conventional printing device cannot necessarily provide the user with a satisfactory printed result.

Aspects of the present invention are advantageous in that there can be provided one or more improved printing devices, and printing methods and computer readable media therefor that make it possible to print a plurality of images so as to efficiently apportion the images onto a predetermined number of papers.

According to aspects of the present invention, there is provided a printing device, which includes a data acquiring unit configured to acquire a numerical number of image files to be printed, an input accepting unit configured to accept an external input for specifying a numerical number of papers to be printed, a printing pattern determining unit configured to determine a numerical number, layout, and size of images to be printed on each paper based on the numerical number of image files that is acquired by the data acquiring unit and the numerical number of papers that is specified through the input accepting unit, and a printing unit configured to perform a printing operation based on the numerical number, layout, and size of images to be printed on each paper that are determined by the printing pattern determining unit.

In some aspects, based on the numerical number of image files to be printed that is acquired by the data acquiring unit and the numerical number of papers to be printed that is specified through the input accepting unit, the printing pattern determining unit determines the numerical number, layout, and size of images to be printed on each paper. Then, the printing unit performs the printing operation based on the numerical number, layout, and size of images to be printed on each paper that are determined by the printing pattern determining unit. Therefore, it is possible to print a plurality of images so as to be appropriately apportioned onto papers of the number specified by the user, so that a blank space can be made as small as possible and the image size can be made as large as possible on each of the specified number of papers.

According to another aspect of the present invention, there is provided a printing method, which includes a first step of acquiring a numerical number of image files to be printed, a second step of accepting an external input for specifying a numerical number of papers to be printed, a third step of determining a numerical number, layout, and size of images to be printed on each paper based on the numerical number of image files that is acquired in the first step and the numerical number of papers that is specified in the second step, and a fourth step of performing a printing operation based on the numerical number, layout, and size of images to be printed on each paper that are determined in the third step.

According to the printing method configured as above, the same effects as the aforementioned printing device can be provided.

According to a further aspect of the present invention, there is provided a computer readable medium having computer readable instructions stored thereon, which cause a computer to perform a first step of acquiring a numerical number of image files to be printed, a second step of accepting an external input for specifying a numerical number of papers to be printed, a third step of determining a numerical number, layout, and size of images to be printed on each paper based on the numerical number of image files that is acquired in the first step and the numerical number of papers that is specified in the second step, and a fourth step of performing a printing operation based on the numerical number, layout, and size of images to be printed on each paper that are determined in the third step.

According to the computer readable medium configured as above, the same effects as the aforementioned printing device can be provided.

### BRIEF DESCRIPTION OF THE ACCOMPANYING DRAWINGS

FIG. 1 is a block diagram of a printing device in an embodiment according to one or more aspects of the present invention.

FIG. 2 is a flowchart showing a procedure of a printing process to be executed a computer program for printing in the embodiment according to one or more aspects of the present invention.

FIG. 3 schematically shows 3 printed papers onto which 11 images are apportioned and printed in the embodiment according to one or more aspects of the present invention.

FIG. 4 schematically shows 2 printed papers onto which the 11 images are apportioned and printed in the embodiment according to one or more aspects of the present invention.

FIG. 5 schematically shows a single printed paper onto which the 11 images are printed in the embodiment according to one or more aspects of the present invention.

FIG. 6 schematically shows 2 printed papers onto which the 11 images are apportioned and printed with different image sizes between the 2 papers in the embodiment according to one or more aspects of the present invention.

FIG. 7 is an example of a screen image displayed on a display unit of the printing device in the embodiment according to one or more aspects of the present invention.

FIGS. 8A to 8E schematically show various templates each of which defines arrangement of a different number of images on a single paper in the embodiment according to one or more aspects of the present invention.

FIG. 9 exemplifies a single paper onto which 11 images are printed with a conventional printing device.

FIG. 10 exemplifies 2 papers onto which 11 images are apportioned and printed with the conventional printing device.

### DETAILED DESCRIPTION

It is noted that various connections are set forth between elements in the following description. It is noted that these connections in general and, unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

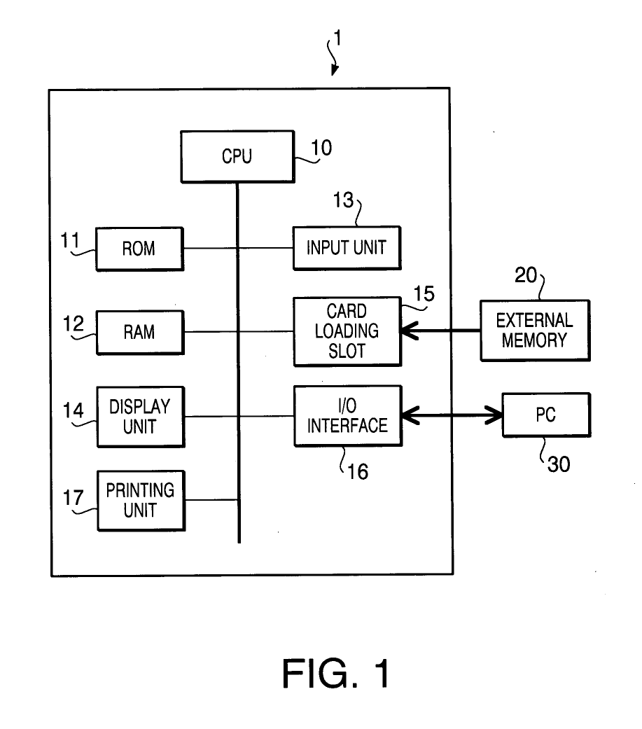

Hereinafter, an embodiment according to aspects of the invention will be described with reference to the accompanying drawings. A printing device and a computer program for printing in the present embodiment are configured such that when a user prints a plurality of images taken by a digital camera or the like onto papers of a predetermined size, the plurality of images are printed therewith so as to be efficiently apportioned onto a specified number of papers. FIG. 1 is a block diagram schematically showing a configuration of a printing device 1 configured as above in the present embodiment. A computer program configured as above is stored in the printing device 1.

The printing device 1 is provided with a ROM 11 that stores thereon the computer program for printing, RAM 12 that temporarily stores thereon image data under processing, input unit 13 that accepts a user input operation therethrough, display unit 14 that displays thereon necessary information such as a current processing state and inputted data, card loading slot 15 into which an external memory 20 such as a memory card is inserted, Input/Output (I/O) interface 16 through which data communication is performed with an external device such as a personal computer, printing unit 17 that forms a colored image onto a paper based on image data, and control unit (CPU) 10 that controls the aforementioned ROM 11 and printing unit 17. The printing device 1 performs the following printing operation.

When printing an image with the printing device 1, firstly, image data are read and stored into the RAM 12. For example, the image data may be stored into a Memory Stick inserted in a digital camera. Then, the Memory Stick is inserted into the card loading slot 15, and the image data are read. Further, image data, which are stored in a built-in memory of a digital camera or a hard disk drive of a personal computer (PC) 30, may be read via a communication cable connected to the I/O interface 16. Then, a printing process for the acquired image data will be carried out with the printing device 1 in accordance with the following procedure.

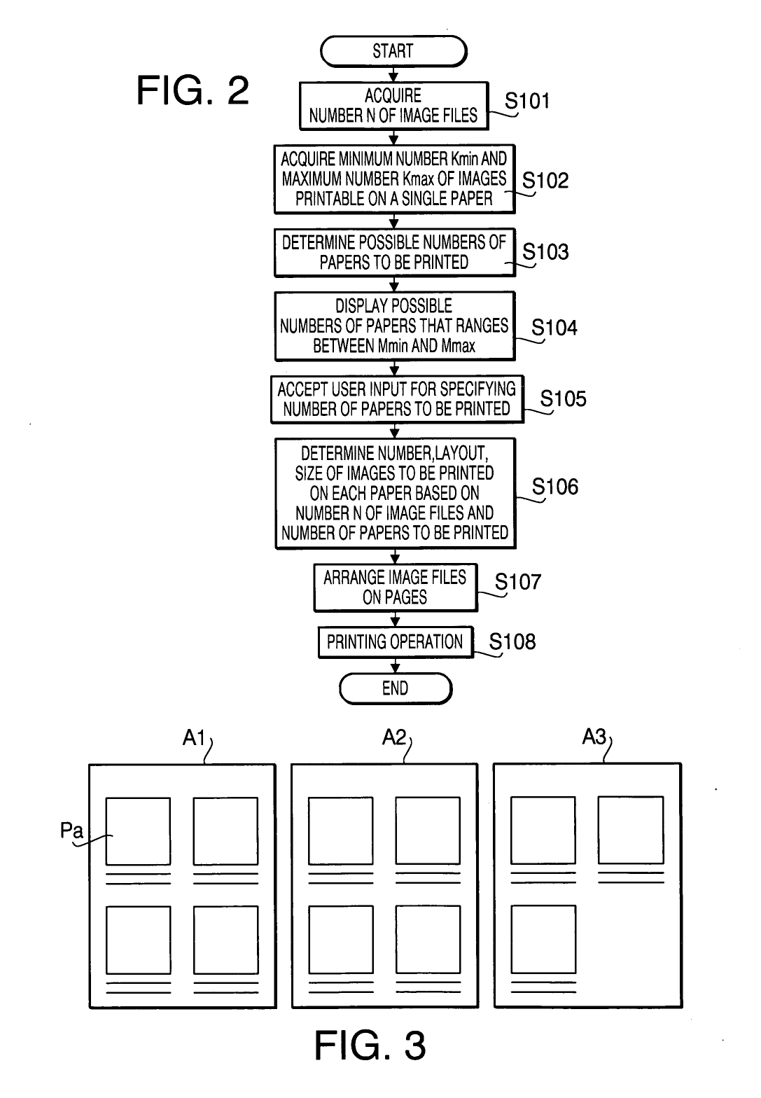

FIG. 2 is a flowchart showing the procedure of the printing process, which is executed with the computer program for printing. When the image data are read as described above, the printing device 1 acquires a number N of image files included in the image data (S101). For example, when the number N of the image files stored in a predetermined folder is 11, the printing device 1 can acquire information that there are 11 subject images to be printed, by reading the image data from the folder.

Subsequently, there are confirmed a minimum number Kmin and a maximum number Kmax of images printable on a single paper (S102). Then, the possible numbers of papers to be printed are determined based on the acquired information including the aforementioned N, Kmin, and Kmax (S103). When a plurality of images are printed so as to be arranged on a single paper, appropriate numbers of images that can be arranged on a single paper are determined as shown in FIGS. 8A to 8E, and the maximum number Kmax of printable images is determined depending on a paper size. In the printing device 1 of the present embodiment, the minimum number Kmin and the maximum number Kmax are set to be “1” and “30,” respectively, which are stored as table values.

Further, in the printing device 1 and the computer program for printing of the present embodiment, a plurality of images are printed so as to be efficiently apportioned onto a predetermined number of papers. Here, “to efficiently apportion a plurality of images onto a predetermined number of papers” means the following operation. When the number of papers is less than the number N of the image files, a plurality of images are printed on a single paper. In such a case, printing is carried out such that a blank space can be minimized on a paper, and such that the plurality of images are arranged with as a large size as possible on each of the predetermined number of papers.

Accordingly, the computer program for printing is configured to print the plurality of images on papers of a number specified by the user, there are determined in S103, possible numbers of papers onto which the image files can be apportioned.

The possible numbers of papers range between a minimum number Mmin (N/Kmax) obtained by dividing the number N of the image files by the maximum number Kmax of printable images on a single paper and a maximum number Mmax (N/Kmin) obtained by dividing the number N of the image files by the minimum number Kmin of printable images on a single paper. Each of the minimum number Mmin and the maximum number Mmax is determined by rounding up the number below the decimal point. For example, when the number N of the image files is “11,” the possible numbers of papers range between Mmin “1” and Mmax “11.” Thus, the Mmax of the possible numbers of papers is equivalent to the number N of the image files. Meanwhile, the Mmin of the possible numbers of papers equals “1” when the number N of the image files is equal to or less than the Kmax “30,” and the Mmin varies to be “2,” “3,” . . . , when the number N of the image files is more than the Kmax “30.”

Then, the possible numbers of papers are displayed on the display unit 14 (S104). When the number N of the image files equals “11,” numbers of “1” to “11” are displayed on the display unit 14. The display unit 14 has a touch panel function, so that the number of papers to be used is determined when the user touches an intended one of the numbers displayed thereon (S105). When the number of papers to be used is determined, the number, layout, and size of images to be printed on each paper are determined based on the number N of the image files and the number of papers to be used (S106).

In this case, the number, layout, and size of images on each paper may be calculated on a page-by-page basis. However, in the present embodiment, there are stored as a table, various templates in each of which there are defined the number, layout, and size of images to be printed on a single paper. Therefore, in S106, a desired template is selected based on the number N of the image files that is acquired in S101 and the number of papers to be used that is obtained in S105. Then, in accordance with the selected template, the image files are arranged on papers (S107). Thereafter, in accordance with the arrangement, an actual printing operation is performed on the papers with the printing unit 17 (S108). It is noted that there are prepared in the present embodiment, respective templates for “2,” “4,” “6,” “8,” “10,” “12,” and “18” as the numbers of images to be printed on a single paper.

FIGS. 3 to 5 schematically show 3 patterns in each of which 11 images are printed on one or more papers with the printing device 1 of the present embodiment. For example, FIG. 3 shows printed papers in case where “3” is selected from the possible numbers of papers that are displayed on the display unit 14 in S105. In this case, based on the specified number of papers, there is selected in S106 a template with 4 images printable on a single paper. Then, 4 images Pa are printed on each of two papers A1 and A2 among 3 papers, while 3 images Pa are printed on the other paper A3, as shown in FIG. 3 (S107, S108).

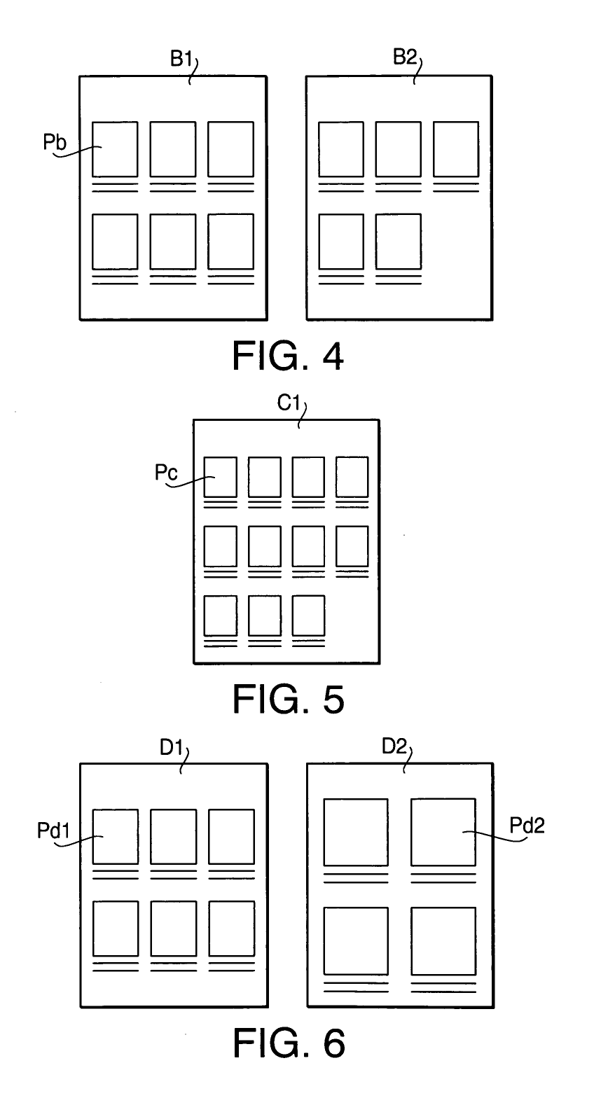

Meanwhile, when the user selects “2” from the possible numbers of papers that are displayed on the display unit 14 in S105, there is selected in S106 a template with 6 images printable on a single paper. In this case, 6 images Pb are printed on a paper B1, while 5 images Pb are printed on the other paper B2, as shown in FIG. 4 (S107, S108).

Furthermore, when the user selects “1” from the possible numbers of papers that are displayed on the display unit 14 in S105, there is selected in S106 a template with 12 images printable on a single paper. In this case, 11 images Pc are completely printed on a paper C1, as shown in FIG. 5 (S107, S108).

Thus, according to the printing device 1 and computer program for printing in the present embodiment, 11 images are printed so as to be efficiently apportioned onto papers of a specified number in any of the cases shown in FIGS. 3 to 5. Specifically, on any of the papers A3, B2, and C1, there is a blank space as large as a single image. Additionally, in any of the cases shown in FIGS. 3 to 5, images apportioned onto the papers of the specified number are printed with as a large size as possible. Thereby, the user can see the images printed to be the easiest to see. Further, the plurality of images are apportioned in a balanced manner onto the papers of the specified number, and printed so as to minimize the blank space. Hence, as shown in FIGS. 3 and 4, the apposed printed papers (A1, A2, and A3, and B1 and B2) gives a favorable visual impression.

Furthermore, according to the present embodiment, there are not required troublesome operations of calculating the number of images to be arranged on a single paper based on the number N of the image files to select a template. The user has only to specify the number of papers to be used.

In the meantime, when the user selects “2” as the number of papers to be used in case where there are 10 image files to be printed, 5 images have to be arranged on each paper to evenly separate the 10 images. However, since the images are arranged to occupy 6 areas provided in the selected template as completely as possible, 6 images are generally disposed on a first paper. In this case, there is generated a blank space as large as 2 images on the second paper, and it gives an unfavorable impression that the blank space is wasteful. In order to overcome this problem, a separate template may be selected for a final paper (on which a final image is to be printed) on which a blank space would be generated when using the template selected for the other previous paper(s).

When the user selects “2” as the number of papers to be used in case where there are 10 image files to be printed, the template with 6 images printable on a single paper is firstly selected in a generally executed manner in S102 shown in FIG. 2. Then, there is selected for the final paper, a template in which remaining images to be printed on the final paper can be disposed with as a large size as possible. Accordingly, as shown in FIG. 6, the 10 images are apportioned into 6 images and 4 images, and images Pd1 and Pd2 with respective different sizes are printed on respective papers D1 and D2.

On the other hand, there may be a case where the user does not prefer different image sizes between the papers. Therefore, when there would be generated a blank space as large as 2 images or larger, the blank space may be apportioned onto other papers such that there is generated a blank space as large as a single image or smaller. When 10 images are printed on 2 papers, 5 images are printed on each paper as the paper B2 shown in FIG. 4.

Further, the user has only to specify the number of papers to be printed. Therefore, when the user has a limited number of papers, the user has to specify a number equal to or less than the limited number. However, when the user has a sufficient number of papers, the user can specify an arbitrary number of papers. In such a case, there might be cause a undesired situation in which there are arranged on each of the specified number of papers, images more than expected and it results in a smaller size of each image. In order to avoid such a situation, the display unit 14, which is configured to display thereon the possible numbers of papers to be printed, may display thereon numbers of images to be disposed on each paper so as to correspond to the possible numbers of papers to be printed, as shown in FIG. 6.

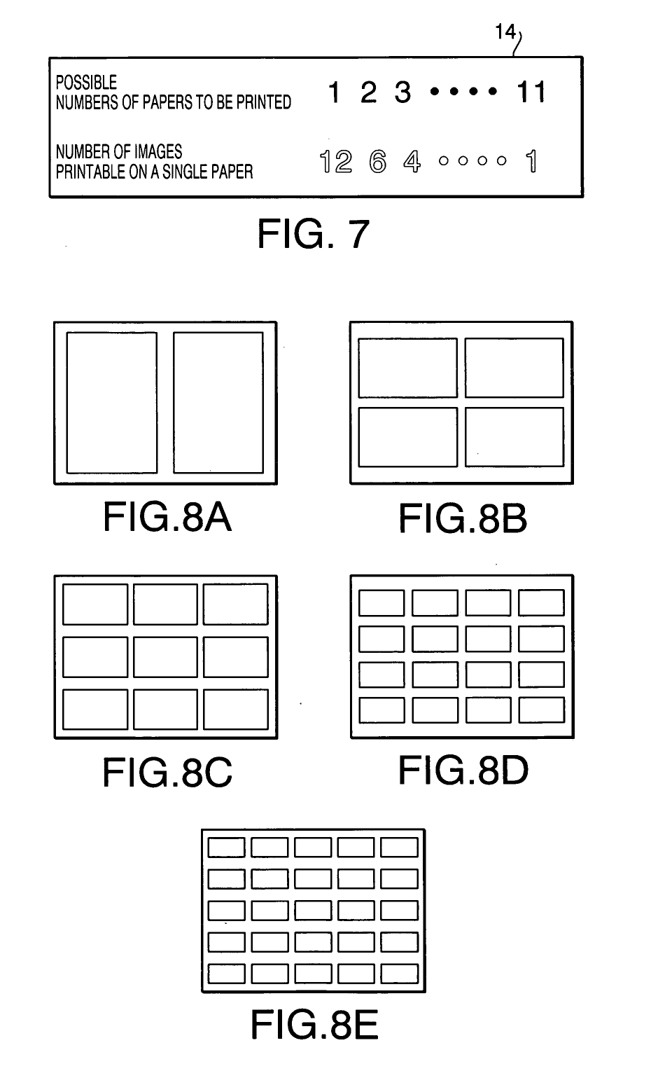

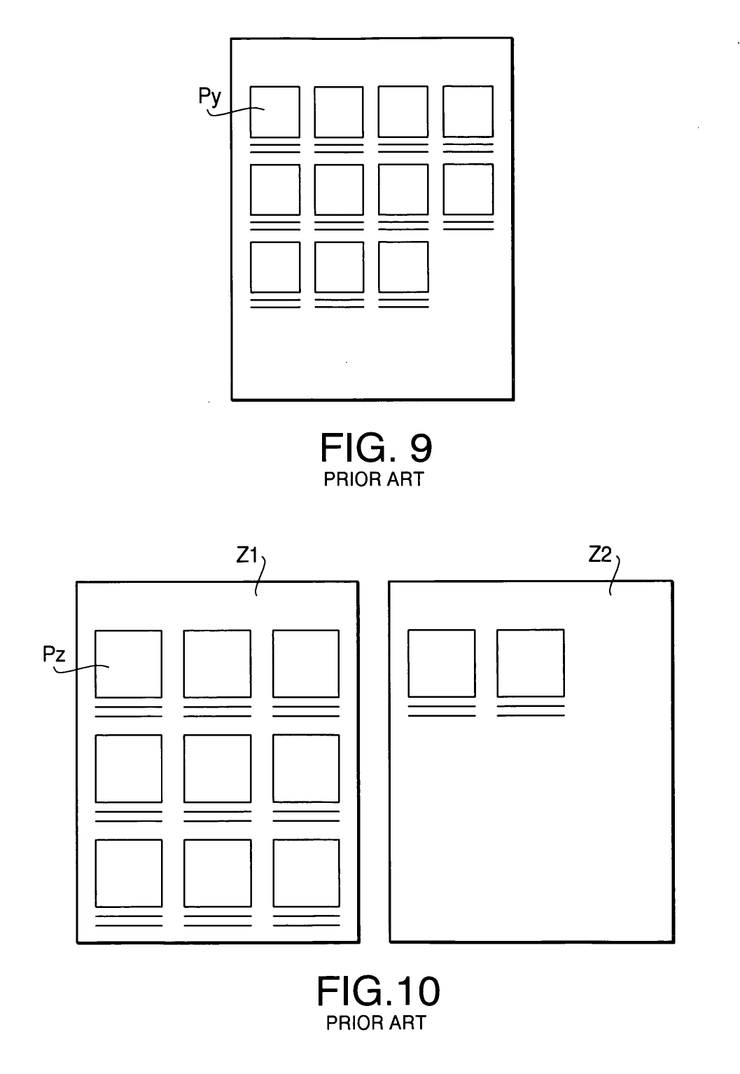

In this case, in the computer program for printing, there are calculated in S103 shown in FIG. 2, as well as the possible numbers of papers to be printed, the numbers of images to be disposed on each paper that correspond to the respective possible numbers of papers to be printed, based on the possible numbers of papers to be printed and the previously stored templates. Additionally, the result is displayed on the display unit 14 in S104 as shown in FIG. 7. Thus, the user can easily check how many images are to be disposed on each paper in case of a desired number of papers to be printed. Thereby, the user can avoid mistakenly selecting the number of papers to be printed.

For example, when there are 11 image files to be printed and the aforementioned templates are stored, the relationship between the number of papers to be printed and the maximum number of images printable on a single paper in a corresponding template is given as shown in FIG. 7. Additionally, when the number of papers to be printed is “4” or “5” (not shown), the maximum number of images printable on a single paper is “4.” Further, when the number of papers to be printed is any of “6” to “10” (not shown), the maximum number of images printable on a single paper is “2.” For instance, when “4” or “5” is selected as the number of papers to be printed, the template with 4 images printable on a single paper is selected. Namely, although the 11 images can be printed only on 3 papers with the selected template, 4 or 5 papers are used in this case. Consequently, it generates a wasteful blank space on a paper and a wasteful printed paper. In addition, when any of “7” to “10” is selected as the number of papers to be printed, the template with 2 images printable on a single paper is selected. Namely, although the 11 images can be printed only on 6 papers with the selected template, 7 or more papers are used in this case. Consequently, it generates a wasteful blank space on a paper and a wasteful printed paper. Therefore, when there are two or more options as the number of papers to be printed with the same maximum number printable on a single paper, the display unit 14 may be configured to display thereon only the smallest number of the two or more options such that the user can avoid selecting the other larger numbers. Thereby, it is possible to prevent a wasteful blank space and a wasteful printed paper.

In the meantime, the computer program for printing that is configured to execute the aforementioned printing process is stored in the ROM 11 of the printing device 1 in the present embodiment. However, the computer program may be stored on a removable recording medium such as a CD-ROM, FD, and MO. In such a case, a PC in which the computer program is installed may be used as a print control device. The PC in which the computer program is installed can perform the steps S101 to S107. Then, a print command signal that includes the image files and layout data representing layout of the image files is sent to the printing device, the same printing operation as described above can be performed with the printing device.

Hereinabove, the embodiments according to aspects of the present invention have been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

For example, when the possible numbers of papers are displayed on the display unit 14, the display unit 14 cannot completely display thereon the possible numbers of papers in case of too many possible numbers of papers along with too many image files. In such a case, when there are more than 10 possible numbers of papers, the display unit 14 may be configured to switch a screen image every time 10 possible numbers of papers are displayed thereon so as to display all of the possible numbers of papers. In addition, the printing device 1 may be configured such that a desired one of the possible numbers of papers can be inputted through a numeric keypad of the input unit 13.

Further, for example, when the user specifies one of the possible numbers of papers that are displayed on the display unit 14, the display unit 14 may be configured to display thereon information regarding how many images are arranged on each paper, and as how many images a blank space on the final paper is as large. Furthermore, the display unit 14 may be configured to display thereon “OK” and “Cancel” so as to induce the user to make final confirmation and re-specify the number of papers to be used.

What is claimed is:

1. A printing device, comprising:
a data acquiring unit configured to acquire a numerical number of image files to be printed;
an input accepting unit configured to accept an external input for specifying a numerical number of papers to be printed;
a printing pattern determining unit configured to determine a numerical number, layout, and size of images to be printed on each paper based on the numerical number of image files that is acquired by the data acquiring unit and the numerical number of papers that is specified through the input accepting unit; and
a printing unit configured to perform a printing operation based on the numerical number, layout, and size of images to be printed on each paper that are determined by the printing pattern determining unit.

2. The printing device according to claim 1, further comprising:
a storing unit configured to store therein a minimum number of images printable on a paper; and
a determining unit configured to determine a maximum number of papers to be printed, based on the minimum number of images printable on a paper that is stored in the storing unit and the numerical number of image files; and
a display unit configured to display thereon the maximum number of papers that is determined by the determining unit.

3. The printing device according to claim 1, further comprising:
a storing unit configured to store therein a maximum number of images printable on a paper; and
a determining unit configured to determine a minimum number of papers to be printed, based on the maximum number of images printable on a paper that is stored in the storing unit and the numerical number of image files; and
a display unit configured to display thereon the minimum number of papers that is determined by the determining unit.

4. The printing device according to claim 1, further comprising:
a storing unit configured to store therein a minimum number and maximum number of images printable on a paper; and
a determining unit configured to determine a maximum number and minimum number of papers to be printed, based on the minimum number and maximum number of images printable on a paper that are stored in the storing unit and the numerical number of image files; and
a display unit configured to display thereon at least one of the maximum number and minimum number of papers that are determined by the determining unit.

5. The printing device according to claim 4,
wherein the display unit displays thereon at least one of the maximum number and minimum number of papers along with at least one of the minimum number and maximum number of images printable on a paper that are stored in the storing unit, in such a manner that the maximum number and minimum number of papers are associated with the minimum number and maximum number of images printable on a paper, respectively.

6. The printing device according to claim 5, further comprising:
a second determining unit configured to determine a numerical number of images printable on a paper that corresponds to each of possible numbers ranging between the minimum number and maximum number of papers that are determined by the determining unit,
wherein the display unit displays thereon the possible numbers ranging between the maximum number and minimum number of papers, and the numerical numbers of images associated with the respective possible numbers of papers.

7. The printing device according to claim 6,
wherein, when the possible numbers ranging between the maximum number and minimum number of papers include a plurality of numbers of papers that correspond to a same numerical number of images printable on a paper, the display unit displays thereon a minimum one of the plurality of numbers of papers.

8. The printing device according to claim 1, further comprising a template storing unit configured to store therein various templates each of which defines a maximum number, layout, and size of images printable on a paper,
wherein the printing pattern determining unit selects one of the various templates based on the numerical number of image files acquired by the data acquiring unit and the numerical number of papers that is specified through the input accepting unit, and
wherein the printing unit performs the printing operation based on the template selected by the printing pattern determining unit.

9. The printing device according to claim 8, further comprising:
a determining unit configured to determine a maximum number and minimum number of papers to be printed, based on a minimum number and maximum number of images printable on a paper of the various templates stored in the template storing unit and the numerical number of image files to be printed;
a second determining unit configured to determine a numerical number of images printable on a paper that corresponds to each of possible numbers ranging between the minimum number and maximum number of papers that are determined by the determining unit; and
a display unit configured to display thereon the possible numbers ranging between the maximum number and minimum number of papers, and the numerical numbers of images associated with the respective possible numbers of papers.
wherein, when the possible numbers ranging between the maximum number and minimum number of papers include a plurality of numbers of papers that correspond to a same numerical number of images printable on a paper, the display unit displays thereon a minimum one of the plurality of numbers of papers.

10. The printing device according to claim 8,
wherein, when a blank space is generated on a final paper, on which a final image is to be printed, with the selected template, the printing pattern determining unit re-selects one of the various templates for the final paper so as to make a size of images to be printed on the final paper as large as possible.

11. The printing device according to claim 1,
wherein, when a blank space is generated on a final paper, on which a final image is to be printed, with the determined layout and size of images to be printed, the printing pattern determining unit re-determines layout and a size of images to be printed on the final paper so as to make the size as large as possible.

12. The printing device according to claim 1,
wherein, when a blank space as large as two images or larger is generated on a final paper, on which a final image is to be printed, with the determined layout and size for the images to be printed, the printing pattern determining unit re-determines a numerical number, layout, and size of images to be printed on each paper.

13. The printing device according to claim 12,
wherein, when a blank space as large as two images or larger is generated on the final paper with the determined layout and size for the images to be printed, the printing pattern determining unit re-determines a numerical number, layout, and size of images to be printed on each paper so as to apportion part of the blank space onto papers other than the final paper.

14. A printing method, comprising:
a first step of acquiring a numerical number of image files to be printed;
a second step of accepting an external input for specifying a numerical number of papers to be printed;
a third step of determining a numerical number, layout, and size of images to be printed on each paper based on the numerical number of image files that is acquired in the first step and the numerical number of papers that is specified in the second step; and
a fourth step of performing a printing operation based on the numerical number, layout, and size of images to be printed on each paper that are determined in the third step.

15. A computer readable medium having computer readable instructions stored thereon, which cause a computer to perform:
a first step of acquiring a numerical number of image files to be printed;
a second step of accepting an external input for specifying a numerical number of papers to be printed;
a third step of determining a numerical number, layout, and size of images to be printed on each paper based on the numerical number of image files that is acquired in the first step and the numerical number of papers that is specified in the second step; and
a fourth step of performing a printing operation based on the numerical number, layout, and size of images to be printed on each paper that are determined in the third step.
